(19) United States
(12) Patent Application Publication
(10) Pub. No.: US 2024/0364131 A1
(43) Pub. Date: Oct. 31, 2024

(54) POWER SUPPLY SYSTEM

(71) Applicant: TOYOTA JIDOSHA KABUSHIKI KAISHA, Toyota-shi (JP)

(72) Inventor: Takashi YAMAGUCHI, Kasugai-shi (JP)

(21) Appl. No.: 18/635,136

(22) Filed: Apr. 15, 2024

(30) Foreign Application Priority Data
Apr. 25, 2023 (JP) 2023-071871

(51) Int. Cl. H02J 7/34; H02J 1/10

(52) U.S. Cl. CPC H02J 7/342; H02J 1/10; H02J 2310/40

(57) ABSTRACT

The power supply system includes a first power supply and a second power supply connected to the first power supply, and a switch device. The battery unit is charged by the first power source and supplies power to the load when power is not supplied from the first power source to the load. The switching device cuts off a connection between the first power supply and the second power supply when a voltage of the first power supply becomes equal to or lower than a threshold value.

### CROSS REFERENCE TO RELATED APPLICATION

This application claims priority to Japanese Patent Application No. 2023-71871 filed on Apr. 25, 2023, which is incorporated herein by reference in its entirety including the specification, claims, drawings, and abstract.

### TECHNICAL FIELD

The present disclosure relates to a power supply system that cuts off a connection between power supplies when a ground fault occurs.

### BACKGROUND

There is known a power supply system in which electric power can be supplied to a load from any of two power sources to make electric power supply redundant.

In the system described in JPA2021-40475, a first system bus transmits power supplied from a first power supply to a first load, and a second system bus transmits power supplied from a second power supply to a second load. An intersystem bus electrically connects the first system bus and the second system bus. The inter-system bus is provided with an inter-system switch that switches between conduction and cutoff of current. In the system, the value of the current discharged from the second power supply is acquired, and when the value of the current exceeds the cut-off threshold, it is considered that the ground fault has occurred, and the intersystem switch is cut off.

### SUMMARY

In a system in which the occurrence of a ground fault is detected by detecting a current as in the system described in JPA-2021-40475, it is determined that a ground fault has occurred when a current exceeding a cutoff threshold value is detected as a result of melting of a fuse provided in a path. However, it takes time until the fuse melts and a current exceeding the cutoff threshold is detected. For this reason, the voltage may decrease during that time, and the load may not be able to be used.

An object of the present disclosure is to cut off a connection between a first power supply and a second power supply earlier than a case where occurrence of a ground fault is detected by detecting a current when a ground fault occurs in a power supply system that includes a first power supply and a second power supply and in which power supply to a load is made redundant.

A power supply system according to the present disclosure includes a first power supply that supplies power to a load, and a second power supply that is connected to the first power supply, and. a switching device. The second power supply is charged by electric power supplied from the first power supply, and supplies electric power to the load when electric power is not supplied from the first power supply to the load. The switching device cuts off a connection between the first power supply and the second power supply when a voltage of the first power supply becomes equal to or lower than a threshold value.

According to the above configuration, when the voltage of the first power supply becomes equal to or lower than the threshold value, the connection between the first power supply and the second power supply is cut off. By detecting the decrease in the voltage, the connection between the first power supply and the second power supply can be cut off earlier than in the case where the occurrence of the ground fault is detected by detecting the current. As a result, the load can be continuously used without generating a period in which the load cannot be used.

According to the present disclosure, in a power supply system including a first power supply and a second power supply, in which power supply to a load is made redundant, when a ground fault occurs, it is possible to disconnect the connection between the first power supply and the second power supply earlier than when a ground fault is detected by detecting a current.

### BRIEF DESCRIPTION OF DRAWINGS

FIG. 1 is a block diagram illustrating a configuration of a power supply system according to an embodiment.

FIG. 2 is a block diagram showing a state of the power supply system when a ground fault occurs.

FIG. 3 is a graph showing a temporal change in voltage when a ground fault occurs at a terminal of the SBW.

### DESCRIPTION OF EMBODIMENTS

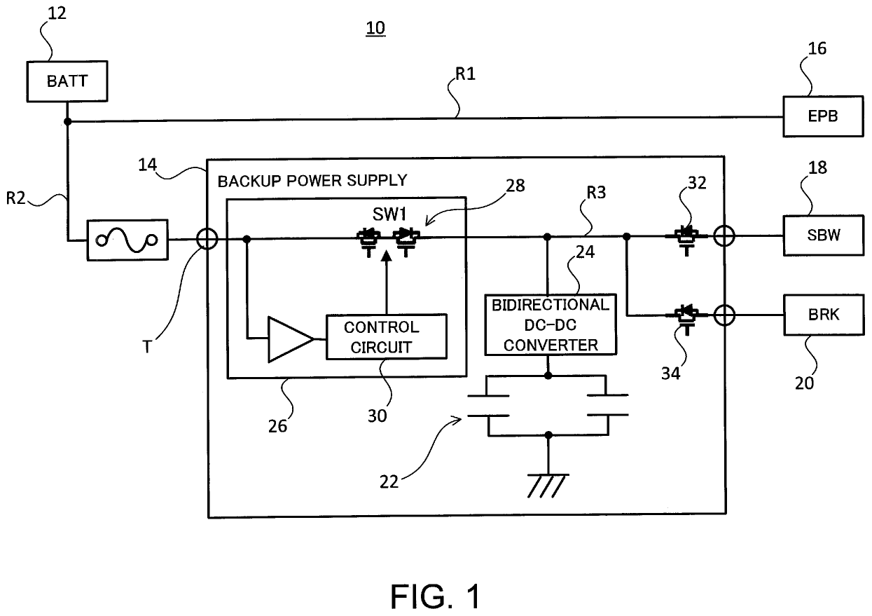

A power supply system 10 according to an embodiment will be described with reference to FIG. 1. FIG. 1 is a block diagram illustrating an example of a configuration of a power supply system 10.

The power supply system 10 is a redundant power supply system applied to mobile object, an apparatus, or the like having a plurality of power supplies. Mobile object is, for example, a vehicle, flying object, such as drone, or a ship. The device is, for example, a machine tool, a construction tool, or a farm tool. Hereinafter, as an example, the power supply system 10 will be described as being applied to a vehicle.

The power supply system 10 includes a main power supply 12, which is a first power supply, and a backup power supply 14, which is a second power supply. The main power supply 12 and the backup power supply 14 are mounted on a vehicle. A plurality of main power supplies 12 and a plurality of backup power supplies 14 may be mounted on the vehicle.

The main power supply 12 and the backup power supply 14 are rechargeable secondary batteries. The charge capacity of the main power supply 12 is larger than the charge capacity of the backup power supply 14. For example, the main power supply 12 is a lead storage battery, and the backup power supply 14 is a storage battery such as a lithium ion battery, a nickel metal hydride battery, or a capacitor.

FIG. 1 shows an EPB 16, a SBW 18, and a BRK 20 as an example of a load mounted on a vehicle. The EPB 16 is an electric parking brake, and is a device for realizing the parking brake by an electric motor. The SBW 18 is a steer-by-wire, and is a device that transmits a steering operation of a driver to wheels by electronic control. The BRK 20 is a brake mounted on a vehicle.

The main power supply 12 supplies electric power stored therein to the EPB 16, the SBW 18, the BRK 20, and the backup power supply 14.

The main power supply 12 and the EPB 16 are connected by a path R1, and the main power supply 12 supplies power to the EPB 16 via the path R1

The main power supply 12 and the backup power supply 14 are connected by a path R2, and the main power supply 12, the SBW 18, and the BRK 20 are connected by paths R2 and R3. The path R3 is a path provided in the backup power supply 14. One end of the path R3 is connected to the path R2, and the other end of the path R3 is connected to the SBW 18 and the BRK 20. The main power supply 12 supplies power to the backup power supply 14, the SBW 18, and the BRK 20 via paths R2 and R3. Power from the main power supply 12 is supplied to the SBW 18 and the BRK 20 via a path R3 in the backup power supply 14. This realizes pass-through power supply via the backup power supply 14. The path R3 is a pass-through path.

The backup power supply 14 supplies power stored therein to the SBW 18 and the BRK 20. The backup power supply 14 can store power supplied from the main power supply 12. The backup power supply 14 is a power supply that supplies power to each load when power is not supplied to each load by the main power supply 12. For example, when power is not supplied from the main power supply 12 to each load due to an event such as a power failure or disconnection, the backup power supply 14 supplies power to each load.

The EPB 16, the SBW 18, and the BRK 20 are merely examples of loads mounted on the vehicle, and power may be supplied to other loads from the main power supply 12 or the backup power supply 14.

The backup power supply 14 includes a battery unit 22, a bidirectional DC-DC converter 24, and a cutoff unit 26.

The battery unit 22 is configured by a lithium ion battery, a nickel metal hydride battery, or a storage battery such as a capacitor. The bidirectional DC-DC converter 24 is provided between the battery unit 22 and the path R3, and is connected to the battery unit 22 and the path R3. The power supplied from the main power supply 12 is supplied to the backup power supply 14 via the bidirectional DC-DC converter 24, whereby the power is stored in the battery unit 22. Power from the battery unit 22 is supplied to each load via the bidirectional DC-DC converter 24.

The cutoff unit 26 is provided on the path R3 in the backup power supply 14. When the voltage of the main power supply 12 becomes equal to or lower than the threshold value, the cutoff unit 26 cuts off the connection between the main power supply 12 and the backup power supply 14.

For example, the cutoff unit 26 includes a switching element group 28 and a control circuit 30. The switching element group 28 includes two switching elements (For example, a field effect transistor (FET).). By connecting the drains to each other, the two FETs are opposed to each other and connected to face each other. Thus, the switching element group 28 is formed. The switching element group 28 corresponds to an example of a switching device.

The control circuit 30 is a circuit that controls switching of each FET included in the switching element group 28. Further, the control circuit 30 detects the voltage of the terminal T. The terminal Tis a terminal that connects the path R2 and the path R3. When the voltage at the terminal T becomes equal to or lower than the threshold value, the control circuit 30 turns off the two FETs included in the switching element group 28. Accordingly, the connection between the main power supply 12 and the backup power supply 14 is cut off. If the voltage at the terminal T exceeds the threshold, the control circuit 30 turns on the two FETs and maintains the state. One end of the path R2 is connected to the main power supply 12, and the other end of the path R2 is connected to one end of the path R3 via the terminal T. Therefore, the voltage of the terminal Tis a voltage output from the main power supply 12. The detection of the voltage drop and the turning-off of the FET are realized by hardware without software. As a result, it is possible to speed up the detection of the voltage drop and the turning-off of the FET.

Switching elements 32 and 34 such as FETs are provided on the path R3. The switching element 32 is connected to the SBW 18, and the switching element 34 is connected to the BRK 20.

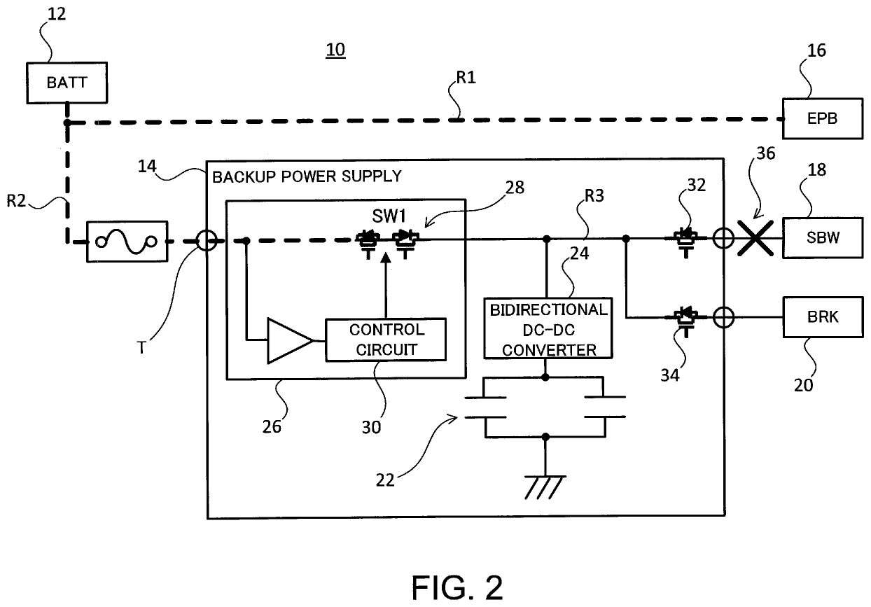

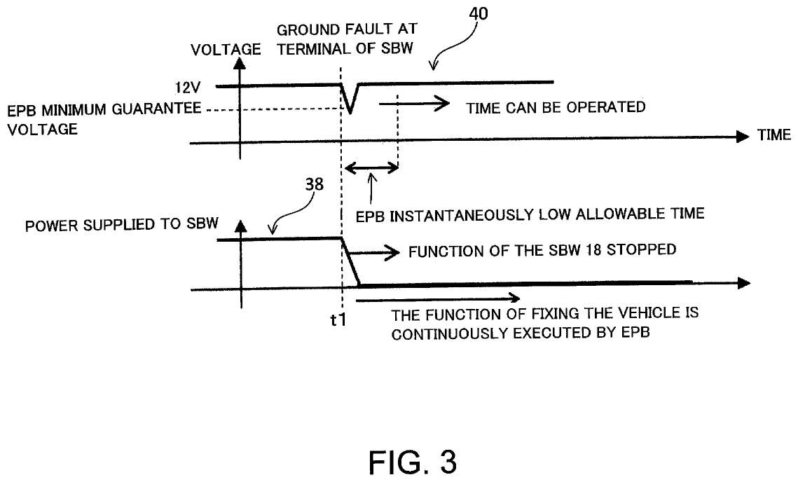

Hereinafter, the operation of the power supply system 10 will be described with reference to FIGS. 2 and 3. FIG. 2 is a block diagram illustrating a state of the power supply system 10 when a ground fault occurs.

As indicated by reference numeral 36 in FIG. 2, it is assumed that a ground fault has occurred at the terminal of the SBW 18. In this case, the voltage output from the main power supply 12 instantaneously decreases. The control circuit 30 detects the voltage at the terminal T. When the voltage detected at the terminal T becomes equal to or lower than the threshold value as the voltage of the main power supply 12 decreases, the control circuit 30 turns off the two FETs included in the switching element group 28. That is, when the voltage of the terminal T becomes equal to or lower than the threshold value, it is assumed that a ground fault has occurred. Therefore, the control circuit 30 turns off the two FETs. Accordingly, the connection between the main power supply 12 and the backup power supply 14 is cut off. Similarly, when a ground fault occurs at a location on the routes R2 and R3, the switching element group 28 is turned off to cut off the connection between the main power supply 12 and the backup power supply 14. In FIG. 2, a portion connected to the main power supply 12 is indicated by a broken line.

FIG. 3 is a graph showing a temporal change in voltage when a ground fault occurs at the terminal of the SBW 18. In FIG. 3, the horizontal axis represents time. A graph 38 is a graph showing a temporal change of the voltage applied to the SBW 18. A graph 40 is a graph showing a temporal change in the voltage applied to the EPB 16.

As shown in the graph 38, when a ground fault occurs at the terminal of the SBW 18 at time t1, power is not supplied to the SBW 18, and thus the voltage applied to the SBW 18 becomes zero. Therefore, the function of the SBW 18 is stopped thereafter.

As the graph 40 shows, immediately after time t1, the voltage applied to the EPB 16 drops. This voltage drop is caused by a ground fault occurring at the terminal of the SBW 18. In the present embodiment, since the switching element group 28 is turned off when the voltage of the terminal T becomes equal to or lower than the threshold value, the connection between the main power supply 12 and the backup power supply 14 is cut off. As a result, since the voltage from the main power supply 12 is applied to the EPB 16, the EPB 16 can be operated.

For example, the threshold is the EPB minimum guaranteed voltage. The EPB minimum guarantee voltage is a minimum voltage required to operate the EPB 16, and is, for example, 8 V. By using the EPB minimum guarantee voltage as the threshold, a voltage equal to or higher than the EPB minimum guarantee voltage can be applied to the EPB 16 before the voltage applied to the EPB 16 becomes lower than the EPB minimum guarantee voltage. Thus, the EPB 16 can be operated without stopping the function of the EPB 16. After the function of the SBW 18 is stopped, the function of fixing the vehicle is continuously executed by the EPB 16.

FIG. 3 shows the allowable EPB instantaneous low time. The EPB instantaneous low allowable time is a time during which even when the voltage applied to the EPB 16 instantaneously decreases, the decrease is allowed. According to the embodiment, even when the voltage applied to the EPB 16 instantaneously decreases, the voltage applied to the EPB 16 increases within the EPB instantaneously low allowable time, and the voltage necessary to operate the EPB 16 continues to be applied to the EPB 16. Thus, the EPB 16 can be continuously operated.

If the connection between the main power supply 12 and the backup power supply 14 is not cut off when a ground fault occurs at the terminal of the SBW 18, the voltage of the main power supply 12 continues to drop, and no voltage is applied to the EPB 16 connected to the main power supply 12. Alternatively, a minimum necessary voltage (EPB minimum guarantee voltage) for operating the EPB 16 is not applied to the EPB 16. Then, the EPB 16 may not operate together with the SBW 18, and the function of fixing the vehicle may not be realized.

According to the present embodiment, even if the function of the SBW 18 is stopped, the EPB 16 can be operated, so that the function of fixing the vehicle can be continuously realized.

In addition, in the system according to the related art in which the occurrence of the ground fault is detected by detecting the current, it is determined that the ground fault has occurred when the fuse provided in the path melts and the current exceeding the cutoff threshold is detected. However, since it takes time to melt the fuse, it takes time to detect a current exceeding the cutoff threshold and determine that a ground fault has occurred. In the meantime, if the voltage drops, the EPB 16 may not be able to be used.

In contrast, according to the present embodiment, by detecting a decrease in voltage and turning off the switching element group 28, the main power supply 12 and the backup power supply 14 can be cut off earlier. As a result, a decrease in the voltage applied to the EPB 16 can be suppressed, and the EPB 16 can be continuously operated.

1. A power supply system comprising:
a first power supply for supplying electric power to a load, and
a second power supply connected to the first power supply, and
a switching device, wherein
the second power supply is configured to be charged with electric power supplied from the first power supply, and configured to supply electric power to the load when electric power is not supplied from the first power supply to the load, and
the switching device is configured to cut off a connection between the first power supply and the second power supply when the voltage of the first power supply becomes equal to or lower than a threshold value.

2. A power supply system according to claim 1, wherein
the switching device comprises two switches opposed to each other and connected therebetween.
